(19) United States
(12) Patent Application Publication
(10) Pub. No.: US 2011/0114509 A1
(43) Pub. Date: May 19, 2011

(54) Method and Apparatus for Removing Impurities from a Liquid

(75) Inventor: Bruce E. Norris, Montgomery, TX (US)

(73) Assignee: Water Vision Incorporated, Montgomery, TX (US)

(21) Appl. No.: 12/621,682

(22) Filed: Nov. 19, 2009

(51) Int. Cl. C02F 1/461; C25B 9/16; C25B 9/18; C25B 15/08

(52) U.S. Cl. 205/687; 204/275.1; 204/273; 204/269; 204/237

(57) ABSTRACT

A method and system for purifying liquid is disclosed that includes combining powdered metal particles with the fluid to be treated. The mixture of powdered metal particles and liquid to be treated is then passed through an electrolytic cell. The cells forms ions which attach to contaminants in the liquid and are subsequently separated out from the liquid using conventional solid/liquid separation techniques.

### BACKGROUND OF INVENTION

1. Field of the Invention

The subject matter disclosed in this application relates to the art of removing impurities and other contaminants, for example organics, from liquids, for example water, using an electrolytic process.

2. Description of Related Art

Electrolytic processes have been in existence for many years. In each case, the prior equipment has been plagued with a continuous buildup of foreign materials on the electrodes which stops the release of metallic ions and causes pitting and damage to the electrodes. As the electrodes are plated with these foreign materials, more voltage is required to maintain the same amount of metal ions being released. The high power eventually causes the unit to stop functioning properly thus requiring the unit to be shut down. Prior attempts to solve the problem include the use of non conductive and even conductive pellets or balls in a fluidized bed to clean the electrodes. Liquid fluidized beds with, for example a four foot per second fluid velocity are inadequate to remove the deposits from the electrodes. Other approaches include reversing the polarity of the electrodes frequently to keep the electrodes clean. Still another approach is to increase the fluid velocity. These approaches have achieved little or no success.

### BRIEF SUMMARY OF THE INVENTION

The present invention prevents the buildup of foreign materials on the electrodes of an electrolytic cell by introducing powdered metal particles into the contaminated water. The powdered metal can be either multivalent metal particles like aluminum, iron, zinc, and magnesium for example, or other coagulating metals whose salts aid coagulation. Multivalent ions, or floc, are produced by the current flowing in the electrode grid, which attracts and attaches to the impurities, both organic and inorganic, and other foreign materials in the water. The metal ions required for flocculation can be produced from appropriate metal powders consisting of one or multiple types of metal powders: iron, zinc, magnesium and aluminum, for example, which can be blended with the feed stream prior to the feed stream entering the main electrolytic cell or introduced directly into the cell. Conventional metal and/or non-fouling noble electrodes or a combination of both can be used in accordance with the invention. This process also destroys pathogens and removes them from the liquid along with the other impurities and contaminants.

### BRIEF DESCRIPTION OF THE SEVERAL VIEWS OF THE DRAWING(S)

FIG. 1 is a diagram of a system for preparing an aqueous solution of the powdered metal particles according to an embodiment of the disclosure.

FIG. 2 is a cross sectional view of an electrolytic cell according to an embodiment of the disclosure.

FIG. 3 is a cross sectional view of a second embodiment of an electrolytic cell according to the disclosure.

FIG. 4 is a cross sectional view of a third embodiment of an electrolytic cell according to the disclosure.

FIG. 5 is an enlarged view of the optional secondary cell.

### DETAILED DESCRIPTION OF THE INVENTION

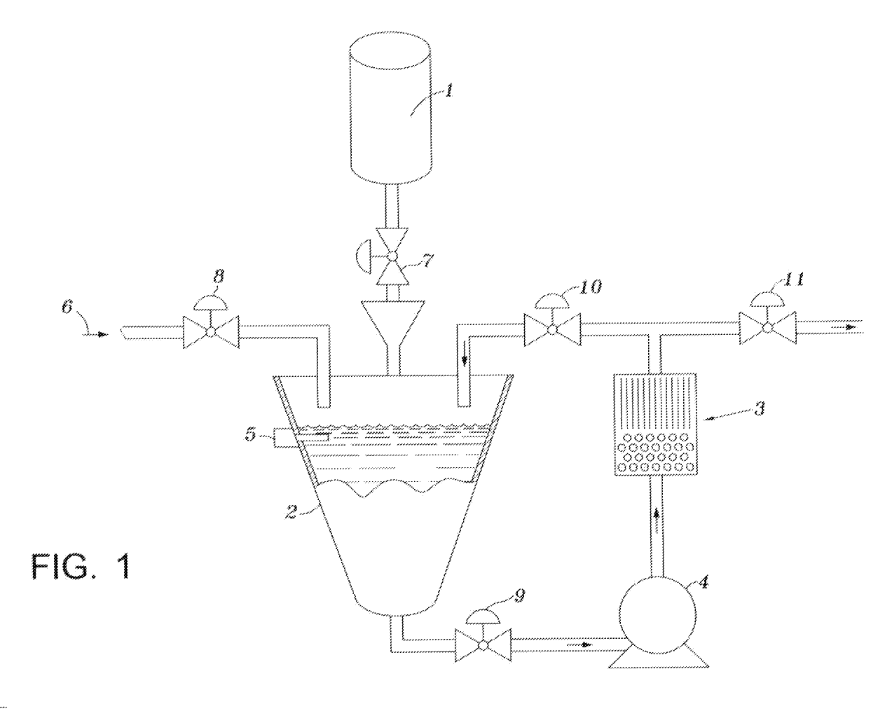

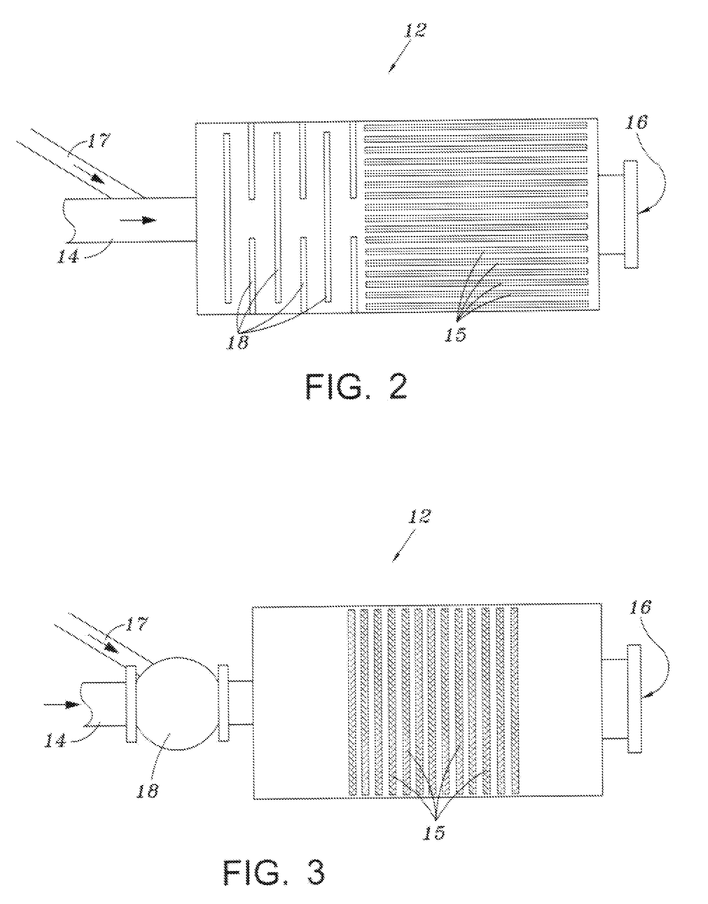

Turning now to FIG. 1, this drawing shows a process for the makeup of the metallic powder liquid stream. Metal powder is added to mixing tank 2 from the metal powder concentrate tank 1 through valve 7. Make up water 6 is added to the mixing tank 2 and the level is controlled by level controller 5 which controls valve 8. Once the level is correct, the mixing tank valve 9 opens, the recirculation valve 10 opens and the powdered metal outlet valve 11 remains closed. The mixing tank recirculation pump is then started and the mixture flows into an optional secondary cell 3 where the metal powder could be consumed during a timed cycle and the metal ions would then flow through the recirculation valve 10 and back into the mixing tank 2. This cycle would continue until all the metal powder is consumed and the metal floc would remain in the mixing tank 2 until metered through the powdered metal outlet valve 11 into the primary cell 12 shown in FIG. 2 at a flow rate which is based on the feed rate of the raw feed 14. If the optional secondary cell 3 is not installed, the flow from the mixing tank recirculation pump 4 would flow through the recirculation valve 10 and back into the mixing tank 2. The continued circulation helps to keep the powdered metal in solution and also acts as the pump which feeds the metal powder injection stream 17 to the primary cell 12. Thus while a secondary cell 3 has been shown in FIG. 1, this is not necessary to carry out the principles according to one embodiment of the invention. Also it is possible to directly introduce the powder particles into the primary cell without prior mixing of any kind.

FIG. 2 illustrates an embodiment of the primary cell. Fluid to be treated is introduced into cell 12 via an input conduit 14. Powdered metal particles may be introduced into the input conduit 14. A plurality of mixing baffles 18 can be provided within the cell for mixing the powdered metal particles with the fluid to be treated. It is noted however that powdered metal input conduit 17 could be directly connected to the primary cell for mixing with the fluid to be treated within the cell itself. A plurality of planar type electrodes 15 are positioned within the cell. The electrodes may be obtained from various sources such as Optimum Anode Technologies. An outlet for the treated fluid is provided at 16. Treated fluid from outlet 16 can be directed to a storage tank where the treated solids and floc can be removed using known techniques. Powdered metal particles up to approximately 0.0625 inches in diameter can be used most effectively.

FIG. 3 illustrates an alternate embodiment of primary cell 12. Primary cell 12 has electrodes 15 which are installed transversely to the flow of the raw feed 14. This type of electrode 15 can be a mesh or expanded metal structure with noble metal coatings such as ruthenium. This type of electrode 15 allows the raw feed 14 and metal powder mixture to flow through the electrodes in lieu of flowing parallel with the electrodes. This arrangement is useful in the removal of some contaminants such as benzene. This arrangement also shows external mixing baffles 18, which act the same way as the mixing baffles 18 shown in FIG. 2.

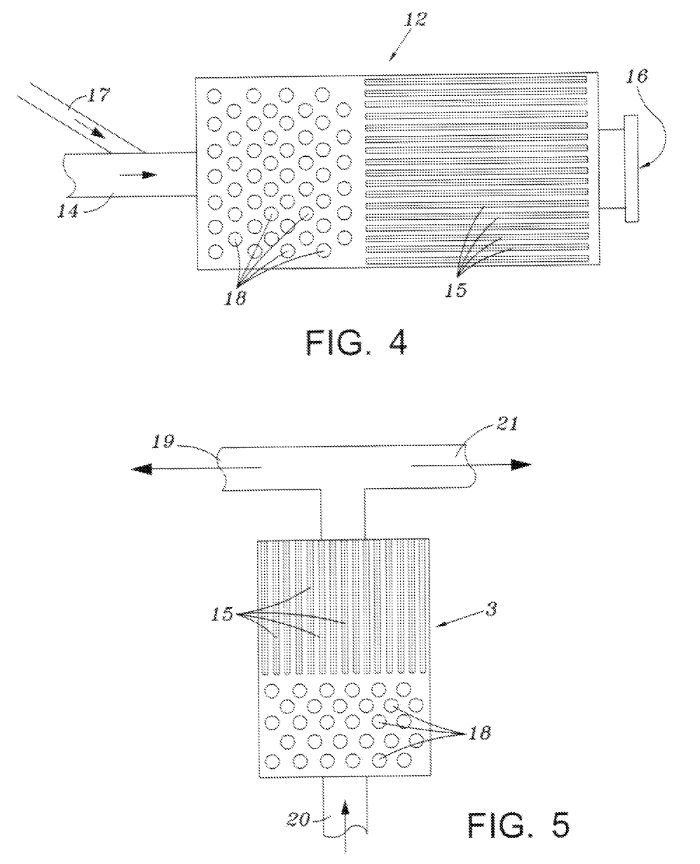

FIG. 4 illustrates a further embodiment of primary cell 12. In this embodiment, the electrodes 15 are shown in a longitudinal array. Mixing baffles 18 are made of round tubing or rods with noble metal coatings which can be connected to alternating current or direct current for additional electrode surface area. The placement of the round mixing baffles 18 which can act as additional electrodes can also allow more residence time of the raw feed in the electrolytic field for the destruction of pathogens. This round tubing coated with a noble metal design can also act as a replacement for the plate or mesh type electrodes 15 used in either the primary cell 12 or the secondary cell 3.

FIG. 5 shows the optional secondary cell 3 and the flow of powdered metal stream through the cell. The powdered metal stream will originate from the inlet from recirculation pump 20 and flow into the mixing baffles 18 which can be tubing, plate or other types of mixing baffles 18 but can also be round tubing coated with a noble coating such as ruthenium and connected to either alternating current or direct current. This design adds additional electrode surface area to the secondary cell 3. The electrodes 15 can be longitudinal noble plates, a noble metal mesh or other noble metal coated types of electrode designs. This optional secondary cell 3 would be used to generate metallic ions which are stored in the mixing tank 2 to be directly injected utilizing the metal powder injection stream 17 into the raw feed 14 stream either ahead of the primary cell 12 or directly into the cell 12.

Although specific details of an embodiment have been disclosed, it is apparent that other arrangements are possible that would fall within the scope of the claims. For example, various mixtures of different powdered metals can be used and separate mixing hoppers can be used for different powdered metals and injected at the same time or separately. The shape and form of the metal electrodes can be plates, wire mesh, round bars or round tubing, or other shapes, and the electrodes in the primary cell could also be a consumable metal such as iron or a mixture of consumable metal and noble metal electrodes. Furthermore the number of electrodes in the primary cell can be selected based on the flow rate and the residence time required to consume the powdered metal.

Additionally, the primary cell and the secondary cell can be powered by direct current or alternating current with voltages and amperage being controlled based on the flow rate and the waste stream being treated. The primary cell can be completely sealed allowing vertical installation or it could be installed horizontally without being sealed. Also multiple primary cells could be employed using different powdered metal from separate mixing hoppers.

In order to prevent any deposits from forming on the electrodes of the primary and secondary cells, the current can be reversed periodically.

Detailed descriptions of the different embodiments are provided herein. It is to be understood, however that the present invention may be embodied in various forms. Therefore, specific details disclosed herein are not to be interpreted as limiting, but rather a basis for the claims and as a representative basis for teaching one skilled in the art to employ the present invention in virtually any appropriately detailed system, structure or manner.

Although the present invention has been described with respect to specific details, it is not intended that such details should be regarded as limitations on the scope of the invention, except to the extent that they are included in the accompanying claims.

I claim:

1. A method for removing impurities from a liquid comprising:
introducing powdered metal particles into a flow of liquid to be treated;
providing a primary electrolytic cell including electrodes;
directing the liquid with the powdered metal particles into the primary electrolytic cell; and
providing an outlet from the electrolytic primary cell for the removal of the treated liquid.

2. A method for removing impurities from liquid comprising:
providing a primary electrolytic cell;
introducing powdered metal particles into the primary cell;
directing liquid to be treated into the primary cell;
combining powdered metal particles with the liquid to be treated within the cell; and
removing the treated liquid from the cell.

3. The method of claim 1 further comprising mixing the metal powdered particles with make up liquid in a tank and recirculating the resultant mixture back into the tank.

4. The method of claim 1 further comprising providing a plurality of baffles within the electrolytic cell for mixing the powdered metal particles with the liquid to be treated;

5. The method of claim 4 wherein the baffles are coated with a noble metal coating and are connected to a source of electrical current.

6. The method of claim 3 further comprising directing the recirculating mixture of powdered metal and make up liquid through a secondary cell thereby forming multivalent ions.

7. The method of claim 1 further comprising introducing the powdered metal and liquid to be treated into a mixing chamber prior to introducing the resultant mixture into the primary cell.

8. The method of claim 6 further comprising introducing a portion of the recirculating mixture into the mixture of powdered metal and treated liquid upstream of the primary electrolytic cell.

9. The method of claim 1 wherein the electrodes of the electrolytic primary cell are formed as plates.

10. The method of claim 1 wherein the electrodes of the primary electrolytic cell are formed of wire mesh.

11. The method of claim 1 wherein the electrodes of the primary electrolytic cell include electrodes formed of a consumable metal.

12. The method of claim 1 wherein the number of electrodes in the primary cell is based on the flow rate and the residence time required to consume the powdered metal.

13. A system for treating liquid comprising:
a primary electrolytic cell having a plurality of electrodes;
a first inlet in the cell for liquid to be treated;
an outlet for the treated liquid;
a source of powdered metal; and
means for introducing the powdered metal into the cell.

14. The system of claim 13 wherein the means for introducing the powdered metal comprises a mixing tank, a supply tank for powdered metal, a conduit for delivering the powdered metal to the mixing tank, a conduit for supplying make up liquid to the mixing tank, and an outlet conduit connected to the primary cell.

15. The system according to claim 14 further comprising a secondary cell located in the outlet conduit.

16. The system according to claim 14 further including a recirculation pump located in the outlet conduit and a return conduit extending from the outlet conduit to the mixing tank, and a recirculating valve positioned in the return conduit.

17. The system of claim 13 wherein the means for introducing the powdered metal into the cell comprises a second inlet in the cell for introducing the powdered metal directly into the cell.

18. The system of claim 13 further comprising a plurality of mixing baffles for mixing the powdered metal and liquid to be treated.

19. The system of claim 13 wherein the electrodes comprise a plurality of plates.

20. The system of claim 13 wherein the electrodes comprise a plurality of wire mesh screens.

21. The system of claim 18 wherein the baffles are located within the primary cell.

22. The system of claim 18 wherein the baffles are planar members or tubular members.

23. The system of claim 18 wherein the baffles are coated with a noble metal and are connected to a source of electrical current.

24. The system of claim 18 wherein the electrodes are formed of a noble metal.

25. The system of claim 18 wherein the electrodes are formed of a consumable metal.

26. The method of claim 1 wherein the electrodes are formed of a noble metal.

27. The method of claim 1 wherein the electrodes are formed of a consumable metal.

28. A method for removing impurities from liquid comprising:
forming multivalent metal ions;
introducing the multivalent metal ions into an electrolytic cell;
directing the liquid to be treated into the electrolytic cell; and
removing the treated liquid and the impurities that have bonded with the metal ions from the electrolytic cell.

29. The method of claim 28 further comprising:
mixing the multivalent metal ions with the liquid to be treated prior to directing the liquid into the electrolytic cell.

30. The method of claim 1 further comprising periodically reversing the polarity of the electrodes to keep the electrodes clear.
